(19) United States
(12) Patent Application Publication
(10) Pub. No.: US 2025/0335903 A1
(43) Pub. Date: Oct. 30, 2025

(54) METHODS FOR PROVIDING DATA FROM A FIRST COMPUTER EQUIPMENT TO A COMPUTER EQUIPMENT ADAPTED TO MANAGE THE DATA

(71) Applicants: DAS-GATE ACCESS CONTROL SOLUTIONS S.L., TAJONAR (ES); VERIDAS DIGITAL AUTHENTICATION SOLUTIONS, S.L., TAJONAR (ES)

(72) Inventors: EDUARDO AZANZA LADRÓN, TAJONAR (ES); CARLOS ARANA REMÍREZ, TAJONAR (ES); JAVIER RUIZ ARANGUREN, TAJONAR (ES); MIGUEL ÁNGEL SÁNCHEZ YOLDI, TAJONAR (ES); FAUSTO ENRIQUE LOPEZ JARA, TAJONAR (ES)

(21) Appl. No.: 18/861,054

(22) PCT Filed: Jun. 16, 2022
(86) PCT No.: PCT/EP2022/066532

§ 371 Date: Oct. 28, 2024

(30) Foreign Application Priority Data
Apr. 29, 2022 (EP) 22382416.0

(51) Int. Cl. G06Q 20/36

(52) U.S. Cl. CPC G06Q 20/3674

(57) ABSTRACT

A method for providing data from a first computer equipment to a computer equipment adapted to manage the data is provided. The method includes providing one or more digital wallets, wherein each digital wallet comprises data related to a subject to be authorized to access the computer equipment adapted to manage the data, selecting a digital wallet among the provided digital wallets, selecting data related to the subject, from the selected digital wallet, based on a service provider associated to the computer equipment adapted to manage the data and providing the selected data related to the subject to the computer equipment adapted to manage the data. Computer equipment and computer programs suitable for performing such methods are also provided. Methods for managing data sent from a first computer equipment are also provided.

This application claims the benefit of European Patent Application EP22382416.0 filed 29 Apr. 2022.

The present disclosure relates to methods for providing data from a first computer equipment to a computer equipment adapted to manage the data, and to computer equipment and computer programs suitable for performing such methods.

The present disclosure further relates to methods for managing data provided by the first computer equipment, and to computer equipment and computer programs suitable for performing such methods.

### BACKGROUND

Nowadays, digital information has become a key member of society, as it reaches every aspect of routine at work, at leisure time, at the administration and at practically every task performed daily. This fact has been particularly important thanks to the development of internet-enabled portable devices and the increase of their computing power, which has provoked them to be used in the same manner as computers.

Under this context, using e.g., the mobile phone to perform sensitive operations in terms of accessed information, the operation itself and confidentiality has also become more common among the users.

Authentication is the act of confirming the identity of an object or entity. This might involve confirming the identity of a person or software program, tracing the origins of an artifact, or ensuring that a product is what its packaging and labeling claims it to be. Authentication often involves verifying the validity of at least one form of identification.

The ways in which someone may be authenticated fall into three general categories, known as the factors of authentication: something the user knows, something the user has, and something the user is. Each authentication factor covers a range of elements used to authenticate or verify a person's identity prior to being granted some form of access or authority.

The process of authorization is distinct from that of authentication. Whereas authentication is the process of verifying that “you are who you say you are”, authorization is the process of verifying that “you are permitted to do what you are trying to do” i.e., access a system, access a room or car, access a club or event, permit to do a transaction etc. Authorization therefore requires prior authentication.

The process of authentication, has a number of well-known issues, including:
a. Users may store access credentials in a sheet or document, which if compromised provides access to identity and other authentication information,
b. Users may synchronize all passwords and use a common password, which if compromised provides access to all systems,
c. Users may use a tool, such as a password manager, but still are forced to keep track of the creation of new accounts and passwords, reset/renew the credentials, and then ensure the password manager is updated accordingly,
d. Every time the user is creating another account, by adding a new username/password combination, this is associated with an expanding digital identity presence and consequent increased exposure to fraud,
e. One-time passwords on hardware keys are cumbersome for consumers to carry. They also impose significant cost overheads for issuers, such as banks, and have been adopted slowly by online service providers,
f. One-time passwords issued via SMS, which is transmitted and shared over the carriers open network, have proved insecure by multiple scenarios of compromise worldwide.

Due to these complexities and cost-overheads, many online authentication systems still rely only on single factor authentication. At the same time, intelligent devices are becoming ubiquitous, forcing consumers to carry an increasing number of special keys, and maintain an ever-growing list of passwords.

Consequently, there is a need for methods and computer equipment that at least partially solve the aforementioned problems.

### SUMMARY

According to a first aspect, a method for providing data from a first computer equipment to a computer equipment adapted to manage the data is provided. The method comprises: providing one or more digital wallets, wherein each digital wallet comprises data related to a subject to be authorized to access the computer equipment adapted to manage the data, selecting a digital wallet among the provided digital wallets, selecting data related to the subject, from the selected digital wallet, based on a service provider associated to the computer equipment adapted to manage the data and providing the selected data related to the subject to the computer equipment adapted to manage the data.

According to this first aspect, a method for providing (and, in some examples, sending) data from a first computer equipment to a computer equipment adapted to manage the data is provided in which the data provided to the computer equipment adapted to manage the data is selected from a subject's digital (ID) wallet (running in the first computing equipment) depending on the service provider (associated to a computer equipment adapted to manage the data). This operation may be triggered in response to a request of the subject to be authorized to access the computer equipment adapted to manage the data (and thus the service provider associated to such computer equipment) or in response to a request of the subject to be authenticated in the computer equipment adapted to manage the data.

A temporary synchronization is thus provided between the first computer equipment and the computer equipment adapted to manage the data during which the selected data is provided (and, in some examples, transferred) from the first computer equipment to the computer equipment adapted to manage the data. The relevant data is stored in digital ID wallet running in a (remote) first computer equipment thus the existence of large, permanent databases associated to the computer equipment adapted to manage the data, which are suitable to store the relevant data, are avoided.

In some examples, a predefined period of time may be assigned to the data related to the subject after which the data related to the subject is to be deleted.

According to this example, the selected data related to the subject which may be provided (and, in some examples, sent) to the computer equipment adapted to manage the data may only be maintained in the first computer equipment or in the computer equipment adapted to manage the data during a pre-defined period of time. This ensures, for example, that the computer equipment adapted to manage the data does not permanently store the data related to the subject which is needed for the user/subject to be authenticated and/or authorized by the computer equipment adapted to manage the data (and thus the service provider associated to such computer equipment). As a result, a relatively secure and private method to provide data to a user which wants to be authorized to access the computer equipment adapted to manage the data is provided.

Moreover, even in the case that that the data related to the subject is not sent to the computer equipment adapted to manage the data, but this data is provided in another form to the computer equipment adapted to manage the data which does not involve an actual delivery of such data to the computer, this data may only be maintained in the first computer equipment during a pre-defined period of time

In a second aspect, a first computer equipment adapted to provide data to a computer equipment adapted to manage the data is provided. The first computer equipment comprises: means for providing one or more digital wallets, wherein each digital wallet comprises data related to a subject to be authorized to access the computer equipment adapted to manage the data. The first computer equipment further comprises means for selecting a digital wallet among the provided digital wallets, means for selecting data related to the subject, from the selected digital wallet, based on a service provider associated to the computer equipment adapted to manage the data and means for providing the selected data related to the subject to the computer equipment adapted to manage the data.

In yet another aspect, a computer program product is disclosed. The computer program product may comprise program instructions for causing a first computer equipment to perform a method according to the first aspect.

In a further aspect, a method for managing data provided by a first computer equipment is provided. The method comprises: obtaining a biometric mathematical representation of physical characteristics of a subject which is to be authorized to access a computer equipment adapted to manage the data. The method further comprises: obtaining one or more first biometric mathematical representations of the subject, comparing the obtained biometric mathematical representation of physical characteristics of the subject with the obtained first biometric mathematical representations; in case of positive result in the comparison, selecting the corresponding first biometric mathematical representation, and sending a subject identifier, associated to the selected first biometric mathematical representation of the subject, to the first computer equipment, wherein the subject identifier is related to the subject which is to be authorized to access a computer equipment adapted to manage the message.

According to this aspect, a method for managing data provided (or sent) by the first computer equipment is provided in which a biometric mathematical representation of physical characteristics of a subject (which wants to be authorized to access the computer equipment adapted to managed the data) is compared with one or more first biometric mathematical representations of the subject such that if there is a match between the biometric mathematical representation of physical characteristics of the subject and one of the first biometric mathematical representation of physical characteristics of the subject, a subject identifier related to the same subject which wants to be authorized to access the computer equipment adapted to manage the data (and associated to the selected biometric first mathematical representation of physical characteristics of the subject) is sent to the first computer equipment. This is performed in order to obtain the necessary data related to the subject from its corresponding digital id wallet running in the first computer equipment.

According to some examples, generating a biometric mathematical representation of physical characteristics of the subject comprises: capturing one or more physical characteristics representative of the subject, each physical characteristic containing a biometric feature of the subject; identifying the biometric feature in the captured physical characteristics and generating a biometric mathematical representation of physical characteristics of the subject.

When verification in the computer equipment adapted to manage the data is required, a new instance is captured and processed to obtain a new biometric features included in a mathematical representation (i.e., biometric mathematical representation of physical characteristics of the subject), and next, this new mathematical representation is compared with the first biometric mathematical representations of the subject (which e.g., may have been previously received and stored in the computer equipment adapted to manage the data) in order to authenticate the subject, thus accepting or denying user authorization.

According to some other examples, obtaining the first biometric mathematical representations of the subject comprises: providing a machine-readable optical label based on the first biometric mathematical representations of the subject and reading the machine-readable optical label to decode the first biometric mathematical representations of the subject.

The proposed procedure includes that biometric data of the subject is transformed e.g., into a first biometric mathematical representation of the subject, and finally this first biometric mathematical representation of the subject is encoded as a sort of machine-readable optical label representation (e.g., a QR code). Then, the mathematical representation is extracted from the QR code.

A biometric mathematical representation of physical characteristics (related to the subject which wants to be authorized to access the computer equipment adapted to manage the data) may be compared with the obtained first biometric mathematical representation of the subject (in order to authenticate the subject), thus accepting or denying user authorization.

As a main feature of the proposed method according to this aspect, it accepts performing biometric authentication on-site, as an alternative to performing it in a remote system (i.e.: server, cloud server, etc.). This schema enables avoiding establishing connections to a remote server, thus avoiding any derived security risk and privacy concerns

Thus, other key points of this disclosure are: the user credential for authentication may be revoked on demand or in a short-time span decided in the moment the credential is given; the disclosed system is low-cost as machine-readable optical labels may be printed in low-resolution and with black and white ink instead of grey-level/colour photographs; and finally, this verification procedure may be integrated as an additional security level and enables performing higher security checks by evaluating the meta-characteristics of the machine-readable optical label itself.

According to a further aspect, a computer equipment adapted to manage data provided by a first computer equipment is provided. The method comprises: means for providing a biometric mathematical representation of physical characteristics of a subject which is to be authorized to access the computer equipment; means for obtaining one or more first biometric mathematical representations of the subject; means for comparing the provided biometric mathematical representation of physical characteristics of the subject with the first biometric mathematical representations of the subject. The method further comprises in case of positive result in the comparison, means for selecting the corresponding first biometric mathematical representation and means for sending a subject identifier, associated to the selected first biometric mathematical representation of the subject, to the first computer equipment, wherein the subject identifier is related to the subject which is to be authorized to access a computer equipment adapted to manage the data.

In yet another aspect, a computer program product is disclosed. The computer program product may comprise program instructions for causing a computer equipment adapted to manage data to perform a method according to the above-commented aspect.

### BRIEF DESCRIPTION OF THE DRAWINGS

Non-limiting examples of the present disclosure will be described in the following, with reference to the appended drawings, in which:

FIG. 1 is a flow chart of a biometric verification process, according to an example;

FIG. 2 is a block diagram of first computer equipment adapted to provide data to a computer equipment adapted to manage the data (associated to a service provider), in accordance with an example;

FIG. 3 is a block diagram of a computer equipment adapted to manage the data sent from the first computer equipment which may be the same or similar to the one explained with reference to FIG. 2, in accordance with an example;

FIG. 4 is a flow chart of a method for providing data from a first computer equipment to a computer equipment adapted to manage the data, according to an example;

FIG. 5 is a flow chart of a method for managing data provided from a first computer equipment, according to an example.

### DETAILED DESCRIPTION OF EXAMPLES

Along the present description and claims the term “credentials” is to be understood as data related to the subject including a first vector representing a biometric feature of the subject, a subject identifier data and/or identification data related to the subject.

Along the present description and claims the term “usage right data” is to be understood as data which verifies that a given statement is true. Particularly, under the so-called zero-knowledge protocol, a first computer equipment (the prover) may prove a second computer equipment (the verifier) that a given statement is true while the prover avoids conveying any additional information apart from the fact that the statement is indeed true.

Along the present description and claims the term “biometric mathematical representation” encompasses e.g., a biometric vector or a biometric matrix.

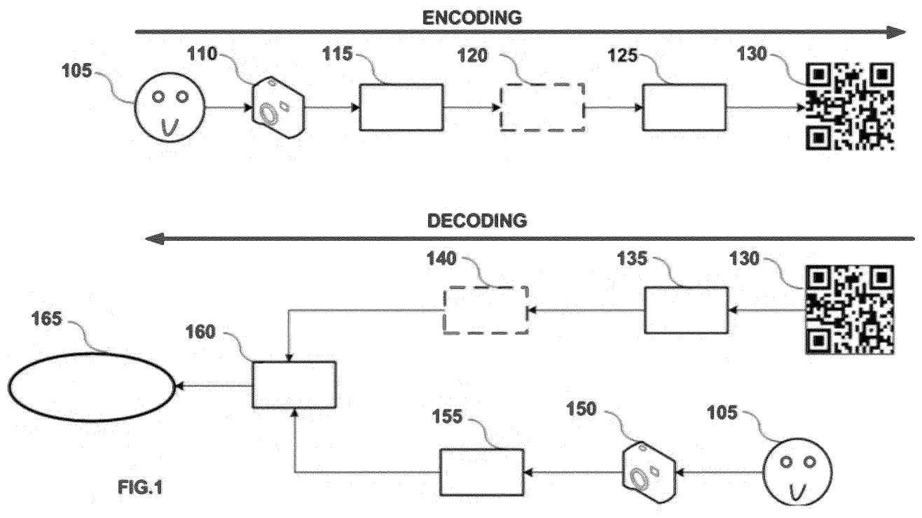

FIG. 1 is a flow chart of a biometric verification process which can be used in a method for managing data provided by a first computer equipment, according to an example; During an encoding mode of operation, the capturing module 110 may capture one or more physical characteristics of a subject 105. The capturing module 110 may be any type of electronic equipment with functionality to capture physical characteristics. For example, the capturing module 110 may be an image capturing device (e.g., a camera, video-camera, electronic peephole etc.), a voice recording device (e.g., microphone) or a fingerprint sensor. It may also be any type of communication or electronic device with capturing functionalities (e.g., a mobile phone, a tablet, laptop or desktop computer with integrated microphone and/or camera etc.). The physical characteristics captured may be any physical characteristic containing a biometric feature. For example, it may be any of (or a combination of) a facial characteristic, a palm characteristic (e.g., a fingerprint), a vocal characteristic, or any other physical characteristic containing a biometric feature. In some examples, capturing the physical characteristic may comprise capturing one or any combinations of an image, an audio, a video, a biological or chemical sample (e.g., able to store genetic information), or any other sample of the subject.

A biometric engine 115 may receive a digital representation of the physical characteristic captured (e.g., in the form of a file) and extract the biometric feature(s) from the digital representation.

The biometric engine provides a biometric mathematical representation e.g., a biometric features vector using different automatic means. In particular, machine learning techniques are very successful to perform this kind of operation. The system is adjusted to discriminate between two instances belonging or not to the same subject. These vectors are produced following these steps:
1. Biometric target location: using a model of the biometric target (e.g., fingerprint or face) a location of the object is computed over the biometric captured data.
   a. In voice biometrics, the target is to locate sequences of recorded signal where human voice is detected.
   b. In image-based biometrics, it is to compute a bounding box where the target object is located.
2. Normalization: the biometric data is extracted from the rest of the data and normalized to reduce object variance.
3. Embedding computation: Mathematical processes are applied to obtain simplified representations of the normalized object (the so-called embeddings). This process can be done through:
   a. Deep neural networks, in the form of convolutional neural networks, can be used for face biometrics, which commonly provide 128 components-length embedding vectors.
   b. Other dimensionality reduction processes that can be adjusted to convert iris, fingerprints, or other biometrics data into an embedding vector.

The biometric engine 115 may be implemented as an end-to-end biometric engine system, in such a way each of the steps enumerated above are not explicitly programmed but learned from examples using machine learning techniques. Operating as an end-to-end system may require specifying a model structure which allows the execution of steps 1, 2 and 3, but the programmer may not need to code explicitly what needs to be done at each step.

The biometric engine 115 may be running on the same device as the capturing module 110 or it may reside in an external or remote server or in a cloud server. The capturing module 110 may be connected directly or wirelessly with the biometric engine 115. The biometric engine 115 may generate a first biometric mathematical representation of the subject (e.g. a first vector representing a biometric feature of the subject). A version of the biometric engine 115 may also be included in the vector or optical label, or linked to the vector.

The vector may be optionally encrypted using encryption module 120 to increase the security of the biometric data, it is possible to encrypt the feature vector using a symmetric or asymmetric algorithm, which can use the person's data to generate a particular encryption key. The vector (either encrypted or unencrypted) may then be transformed by an encoder module 125 into a machine-readable optical label, e.g. a two-dimensional barcode such as a QR code 130.

When addressing the biometric authentication problem through machine-readable optical labels, it should be taken into account the trade-off between system performance, label size and the ability of the capture system to correctly read biometric faints. Particularly for this representation case, a trade-off between system performance and compactness of data in the representation is bound to occur.

Two possible solutions are proposed to turn the embedding feature vector (usually represented using 4 bytes of IEEE754 float numbers) to a machine-readable optical label, being both techniques able to compress the biometric information contained in the embedding vectors:
By directly encoding the embedding vector to a downsized resolution, which could be decreased to 2 bytes per component (16 bits float numbers) or even 1 byte per component (8 bits fixed point real numbers). For example, in face biometrics, its 128 embedding vector can be represented using 4096 bits using 4 bytes floats (128×4×8), 2048 bits using 2 bytes floats and 1024 bits using 8 bits fixed point representations. For these cases, a good trade-off between performance and space (which are inversely correlated) seems to exist on the 2 byte-representation per component.
By transforming the embedding vector, represented with float numbers, to a compact binary representation through machine learning techniques (i.e.: logistic regression+thresholding).

Once a representation of the vector has been obtained (being full, downsized or transformed), it is written in binary format to a machine-readable optical label (like a QR matrix or similar), which is parametrized in terms of size and redundancy, affecting the ability to read the code properly and the available data budget to store the biometric embedding vector and any other required information.

For instance, the following sizes and qualities are possible for face biometrics using QR codes for their representation as machine-readable optical labels:
QR Version 17 with H redundancy. This version has 85×85 components and it can store up to 2264 bits.
QR Version 14 with Q redundancy. It has 73×73 components and can store up to 2088 bits.
QR Version 12 with M redundancy. This QR matrix has 65×65 components and allows to store up to 2320 bits.
QR Version 10 with L redundancy. This version has 57×57 components and stores up to 2192 bits.

Depending on the ability of the capture device to read a large QR, the system will be configured on one of these four QR versions. The version 12 with M redundancy case is particularly useful because 2320−2048=272 additional bits are available to store in the QR code additional information, e.g., metadata related to the capture device, capture timestamp, user personal data, expiration date, access permission data, location permission data, etc.

During a decoding mode of operation, a reader module 135 may read the machine-readable optical label 130 (e.g., a QR code) and decode the first biometric mathematical representation (e.g. the first vector representing biometric feature of the subject). If the vector is encrypted, then a decrypting module 140 may decrypt the encoded physical characteristic captured vector and generate an unencrypted vector.

In another branch of the procedure, a capturing module 150 may capture a physical characteristic of the subject 105. The capturing module 150 may be the same or different than the capturing module 110. It may however comprise functionality to capture a physical characteristic as the capturing module 110. Then, the capturing module may send a digital representation of the physical characteristic captured to biometric engine 155. The biometric engine 155 may be the same as the biometric engine 115.

The biometric engine 155 may similarly generate a biometric mathematical representation of physical characteristics of the subject (e.g. a physical characteristic captured vector)

The biometric mathematical representation of physical characteristics of the subject may be used to pre-authorize the access of a subject/user to a first computer equipment (in particular to pre-authorized the access of the subject to one digital ID wallet belonging to such subject running in the first computer equipment) or to a computer equipment adapted to managed data (in particular to the service provider associated to such computer equipment), as will be explained later on. The biometric mathematical representation of physical characteristics of the subject may also be used to pre-authenticate a subject/user by a first computer equipment or by a computer equipment adapted to managed data.

For example, a physical characteristic captured vector representing the biometric feature of the subject (which has been generated by the biometric engine 155) may be received by the computer adapted to manage the data and this physical characteristic captured vector may be compared with one or more first vectors each first vector representing a biometric feature of a subject. For example, a first vector representing a biometric feature of the subject may be decoded from the machine-readable optical label 130. Alternatively, the first vectors may have been received from the first computer equipment (e.g., from another computer equipment) or they may have been previously stored e.g., in a database. In any case, the comparison may be performed in the comparator module 160 (which may form part of the computer equipment adapted to manage the data).

In case of positive result in the comparison, the subject may be pre-authorized to access the computer equipment adapted to manage the data, as will be explained later on.

Similarly, a physical characteristic captured vector representing the biometric feature of the subject (which has been generated by the biometric engine 155) may be received by the first computer equipment and this physical characteristic captured vector may be compared with one or more first vectors each first vector representing a biometric feature of a subject. For example, a first vector may be decoded from the machine-readable optical label 130. Alternatively, the first vectors may have been selected e.g. from a digital id wallet running in the first computer equipment.

In any case, a comparison may be performed in the comparator module 160. In case of positive result in the comparison, the subject may be pre-authorized to access the first computer equipment, as will be explained later on.

Following the example, the above-commented comparison can be made through any mathematical method that permits to take a decision in terms of the feature vector belonging to a particular person. Some examples of such method would be:
Computing the distance between the embedding vectors through the cosine or Euclidean distance-like metrics, which may be unbounded;
Computing a likelihood of the authentication feature vector belonging to the same person as the one of the reference vector.

Particularly, a score based on mathematical transformations of the previously described metrics (i.e.: sigmoid-like) can be obtained to enable thresholding the output score.

The capturing process may be an automatic capture process. The automatic capture process may consist in an iterative process that checks the compliance of the following statements:
1. Presence of the biometric feature under evaluation (i.e.: in the biometric authentication using faces, the process will look for the presence of a face within the image)
2. Relation between the biometric feature present in the signal and the rest of the information (i.e.: in the biometric authentication using faces, the process will evaluate the relation between the face and the background to check, among other things, if the face belongs to the person actively doing the authentication process). This relation is a measure of the relevance of the biometric feature in the capture.

Iteratively checking those two statements, the capture may be performed and validated whenever sufficient consistency over a sequence of iterations is reached.

Security measures may be in place to assure that both the registration (during the encoding) and the authentication (during the decoding) processes are properly held by a legit user and no attacks to the system or unwanted accesses happen. The proper security measures to apply may depend on two different factors.

The first factor to take into consideration is the location where the process of registration and/or authentication is being held. According to this, two approaches are considered:
Registration/authentication process in a controlled location

This case covers registration/authentication processes being held in a particular place. For instance, controlled locations would be police stations in which identification documents are expedited, bank offices in which bank accounts are created and/or accessed, etc.

On such locations, two possible situations may occur, leading each one to apply different security measures to ensure system performance in adequate conditions:
The registration/authentication process is supervised: This case covers situations in which the registration/authentication process is supervised by a human (i.e.: police controlling the process of identification document creation). Under such situation, the supervisor will be in charge of checking that no spoofing attacks are being performed (i.e.: use of masks or photos, voice replay attacks, etc.).
The registration process is unsupervised: This case covers situations in which the registration/authentication process is not supervised by a human. Under such situations, measures to counter spoofing attacks such as anti-spoofing systems or proof-of-life systems are optional (but recommended) to be added to the registration/authentication system.
Registration/authentication process in an uncontrolled location

This case covers registration/authentication processes being held anywhere, by the use of mobile apps, web services or any other dedicated application.

Thus, in such cases, three levels of security may be added to the registration/authentication system:
Countermeasures to spoofing attacks by using masks, photos, voice replays, etc. are recommended to be added to the registration/authentication system to ensure safety.
Sending the machine-readable optical label content besides the captured physical characteristic to the remote server in order to perform biometric verification in exchange of an authentication token.
An additional level of authentication within the biometric registration/authentication system through a login (using username and password) or through authentication tokens (i.e.: vali-Das authentication system) to avoid unwanted accesses to the biometric registration/authentication system.

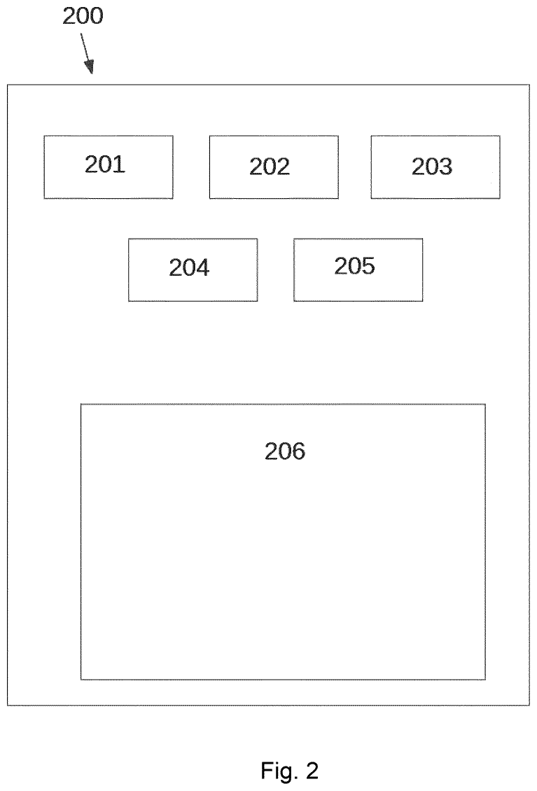

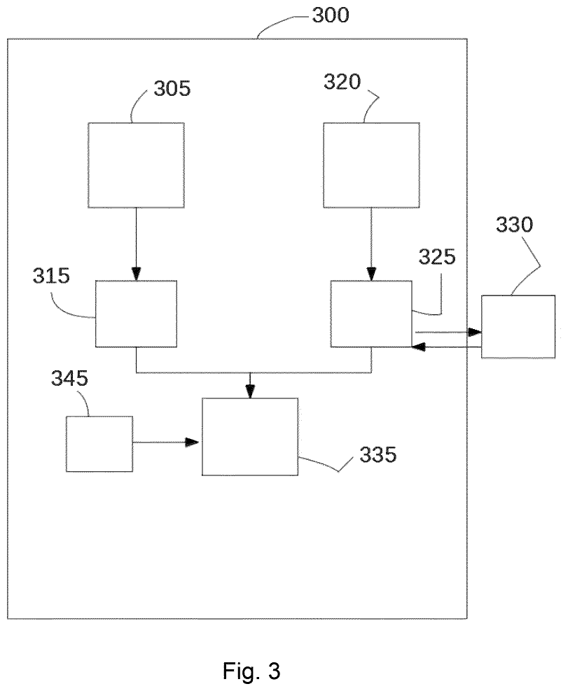

Referring now to FIG. 2, a block diagram of a first computer equipment 200 adapted to provide (and, in some examples, send) data to a computer equipment adapted to manage the data is shown. The first computer equipment 200 is adapted to provide (and, in some examples, send) data to a computer equipment adapted to manage such data (this computer equipment will be explained later on with reference to FIG. 3). The computer equipment adapted to manage the data may be associated to a service provider. Although a number of components are shown as part of first computer equipment 200, it should be appreciated that other, different, more, or fewer components may be found on the first computer equipment 200.

In examples, the first computer equipment 200 may be e.g., a mobile phone, a smart phone, a tablet, a smart watch, a piece of smart jewellery, smart glasses, or other user portable devices having wireless connectivity. The first computer equipment may also be an external server.

For example, first computer equipment 200 may be capable of broadcasting and receiving data with respect to the computer equipment adapted to manage the data (not shown in this figure but explained with reference to FIG. 3) via at least one network, such as, but not limited to, WiFi, Cellular, Bluetooth, NFC, and the like. In examples, the first computer equipment may be capable of providing data to the computer equipment adapted to manage the data merely by providing a QR code which may be read by the computer equipment adapted to manage the data.

In some examples, the first computer equipment may broadcast and receive data with respect to the computer equipment adapted to manage the data via a cloud server (i.e., the first computer equipment may be indirectly connected to the computer equipment adapted to manage the data). The cloud server may be capable to connect the first computer equipment with further computer equipment and to synchronize the delivery and the reception of data with respect to the computer equipment adapted to manage the data. The cloud server may also be configured to add further data to the data sent and received with respect to the computer equipment adapted to manage the data.

Following the example, the computer equipment 200 may include e.g. a display 201, a processor 202, a memory 203, a GPS 204 and a camera 205. In examples, instead of providing GPS information, the location of first computer equipment 200 may be determined within a given radius, such as the broadcast range of an identified beacon, a WiFi hotspot, overlapped area covered by a plurality of mobile telephone signal providers, or the like.

The first computer equipment 200 also may include one or more digital (ID) wallets 206. The different functions of the wallets may be implemented using existing technologies such as: Mobile application, Web application and/or Secure Application on PC.

Particularly, a digital id wallet is an electronic application that operates on the first computer equipment 200. The digital ID wallet holds an identity of the user. These wallets allow a subject/user to have a digital equivalent of some credentials such as official identification documents (eID), driving licenses, vaccination details, national ids, passports, etc. . . . The wallets may also allow a user/subject to a have a digital equivalent of some user rights such as the confirmation that the subject in question is above eighteen years old. Users may thus choose which parts of their identity they share with third parties and monitor what is shared with whom.

Particularly, the digital wallet 206 may include data related to the subject. The data related to the subject may comprise e.g., identification data related to the subject (e.g., national identification number of the subject) and/or a first biometric mathematical representation of the subject in question.

The data related to the subject, contained in the digital wallet 206, may also comprise e.g., an (anonymous) subject identifier. An anonymous subject identifier may be a stable identifier (i.e., does not change) that is unique to a computer equipment, such that the first computer equipment and/or the computer adapted to manage the data may use the anonymous identifier to log the user into the corresponding computer equipment without an online system.

The data related to the subject, included in the digital id wallet, may also comprise usage right data (i.e., data related to the right to use a service provider). As commented above, the digital ID wallet 206 may contain specific data related to the subject i.e., credentials of the subject. However, in some examples, it may not be necessary to share these specific data e.g., with the computer equipment adapted to manage the data. Instead, the first computer equipment 200 may share, with the computer equipment adapted to manage the data, the data related to the right to use the service provider associated to such second computer equipment. For example, the first computer equipment 200 may only share (with the computer equipment adapted to manage the data) the fact that “the subject is older than eighteen years old” or that “the subject lives in a particular place” (without sharing the specific address) or that “the subject has a vaccine in force” (without sharing the number of doses). Therefore, the digital id wallet 206 may share usage data right instead of credentials (e.g., identification data related to the user) and the security of the transmission of information between computer equipment may be improved.

The digital id wallet may also comprise a selfie related to the subject. This may facilitate the integration in the wallet with different service providers associated to the computer equipment adapted to manage the data.

The first computer equipment may further comprise functionality to select a digital wallet among the all the provided digital wallets and to select data within the selected digital wallet based on a service provider associated to a computer equipment adapted to manage the data. The selection of data will be performed based on the service provider to which the user/subject wants to be authorized to access. Once the suitable data is selected, the first computer equipment may send such data to the computer equipment adapted to manage the data, as will be explained later on. For example, the data comprised in the corresponding digital id wallet which may be sent to the computer equipment adapted to manage the data may be one of the following
a first biometric mathematical representation of the subject, specifically a first vector representing biometric feature of the subject,
mathematical data,
a subject identifier data,
identification data related to the subject, and/or
usage right data.

A predefined period of time may be assigned to this data such that, after this period of time, the data sent to the computer equipment adapted to manage the data may be deleted. Particularly, the data may include an expiration date. The computer equipment adapted to manage the previously received data may check regularly (e.g., every hour or every day) whether the data has expired. In case of positive result in the checking (i.e., in case the data has already expired), the data may be deleted from the computer equipment adapted to manage the data.

FIG. 3 schematically illustrates a computer equipment adapted to manage the data provided (and, in some examples, sent) by the first computer equipment.

The computer equipment 300 may comprise a memory 305 to store an image of a machine-readable optical label. In some examples, the machine-readable optical label may have been previously captured and stored using e.g., a capturing device. In any case, the machine-readable optical label may comprise a representation of a biometric feature of a subject. The computer equipment adapted to manage the data 300 may further comprise a reader and a decoding module 315 to decode the machine-readable optical label and to reproduce a first biometric mathematical representation of the subject.

The device 300 may further comprise a capturing module 320 to capture a physical characteristic of the subject. The computer equipment adapted to manage the data 300 may further comprise a biometric gateway 325 to generate a biometric mathematical representation of physical characteristics of the subject based on the biometric feature contained in the captured physical characteristic. The biometric gateway 325 may be connected (locally or remotely) to a biometric engine 330. Alternatively, the biometric gateway 325 may comprise the biometric engine 330.

The computer equipment adapted to manage the data 300 may also comprise a comparing module 335 to compare the biometric mathematical representation of physical characteristics of the subject (provided using the capture module) with one or more first biometric mathematical representations (e.g., provided via a machine readable optical label).

In examples, the first biometric mathematical representations may be stored in a further memory module 345. For example, the first biometric mathematical representations may be received from a digital ID wallet running in the first computer equipment, upon request of the subject.

In case of positive result in the comparison between the biometric mathematical representation of physical characteristics of the subject and the first biometric mathematical representations, the computer equipment may send, to the first computer equipment, a subject identifier related to the subject which wants to access the computer equipment adapted to manage the data (and the service provider associated to such computer equipment).

Further, in response to the subject identifier sent to the first computer equipment, data related to the subject may be received, by the computer adapted to manage the data, from a digital wallet comprised in the first computer equipment. Based on such data related to the subject received from the first computer equipment, the computer adapted to manage the data may authorize the access (or not) of the subject to such computer equipment, as will be explained later on.

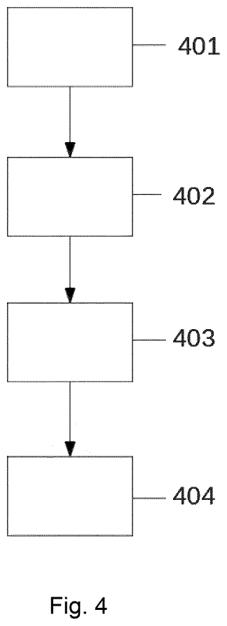

FIG. 4 is a flow chart of a method for providing data from a first computer equipment to a computer equipment adapted to manage the data, according to an example. The first computer equipment and the computer equipment adapted to manage the data described with reference to this figure may comprise a structure and operation as hereinbefore described.

In block 401, one or more digital (id) wallets are provided in the first computer equipment. It is noted that, as commented above, each digital wallet is an electronic application that operates on the first computer equipment 110. The structure and operation of the digital id wallets as well as the data comprised in the digital id wallets may be the same as hereinbefore described. The data comprised in the digital id wallets is related to a user which wants to be authorized to access the computer equipment adapted to manage the data. Particularly, the digital id wallets may comprise:
a first biometric mathematical representation of the subject, specifically a first vector representing biometric feature of the subject,
a subject identifier data,
identification data related to the subject,
mathematical data and/or
usage right data related to the subject.

In block 402, a digital wallet may be selected between the digital wallets running in the first computer equipment. In this respect, the first computer equipment may receive a request from the computer equipment adapted to manage the data. The request may be related to a subject which wants to be authorized to access the computer equipment adapted to manage the data (and a service provider associated to the computer equipment) For example, the subject may want to access to the computer equipment adapted to manage the data associated to a gym facility. As a result, a request is sent, to the first computer equipment, in which it is stated that the subject wants to access such gym facility.

The request, received by the first computer equipment, may include subject identifier data related to the user which wants to access the computer equipment adapted to manage the data associated to the gym facility. The subject identifier data may be an anonymous subject identifier as hereinbefore described. The subject identifier may have been retrieved e.g., from a database and sent to the first computer equipment after the subject has been identified (by biometric or non-biometric means) in the computer equipment adapted to manage the data.

Once the (anonymous) subject identifier data (related to the user which wants to access the computer equipment adapted to manage the data) is received by the first computer equipment, the subject identifier data is compared with the corresponding (anonymous) subject identifier data comprised in the digital wallets running in the first computer equipment. If there is a match between the received subject identifier data and a subject identifier data comprised in one of the digital (id) wallets running in the first computer equipment, the corresponding digital (ID) wallet is selected. This selected digital ID wallet may thus correspond to the subject which wants to access the computer equipment adapted to manage the data associated to the gym facility.

Additionally, the request received by the first computer equipment may require an express acceptance by the subject which wants to access the computer equipment adapted to manage the data associated to the gym facility. In this respect, the first computer equipment may query the subject which wants to access the gym facility to validate the received request to access such gym facility. The first computer equipment may thus query the subject to validate, via a user interface, such request. In case of positive result in the validation of the request by the subject (i.e., in case the request is approved by the subject), the digital wallet may be selected as hereinbefore described.

Moreover, the approval of the request by the subject may require that the subject is identified in the digital (id) wallet, for example by facial recognition. Therefore, in some examples, the first computer equipment may also comprise a structure similar to the one described with reference to FIG. 3.

In this respect, one or more physical characteristics representative of the subject may be captured by the first computer equipment, each physical characteristic containing a biometric feature of the subject. The first computer equipment may also identify the biometric feature in the captured physical characteristics and generate a biometric mathematical representation of physical characteristics of the subject which wants to be identified in the wallet.

The first computer equipment may also comprise a comparing module (not shown) configured to compare the biometric mathematical representation of physical characteristics of the subject with one or more first biometric mathematical representations of the subject. The first biometric mathematical representations may be comprised in the digital (ID) wallets which are running in the first computer equipment, or they may be decoded from a QR code.

In case of positive result in the comparison (i.e., if there is a match between the biometric mathematical representation of physical characteristics of the subject and the first biometric mathematical representation of the subject obtained as hereinbefore described), the request is validated.

In some other examples, a matching score related to the comparison between the biometric mathematical representation of physical characteristics of the subject and the first biometric mathematical representation of the subject comprised in the corresponding digital wallet may be determined. At this point, the subject may be authenticated (and thus the request validated) if the matching score satisfies a predefined threshold.

In block 403, data related to the subject may be selected, from the above-commented selected digital wallet, based on the service provider associated to the computer equipment adapted to manage the data, at which the subject wants to access.

Following the example, the service provider associated to the computer equipment adapted to manage the data may be a gym. Since the correct wallet for the subject which wants to access the computer equipment associated to the gym facilities has already been selected, now the proper data contained in such a selected wallet is also selected based on the service provider, associated to the computer equipment adapted to manage the data, to which the subject wants to access.

In this respect, it may have been pre-established that, in order to be authorized to access the computer equipment adapted to manage the data associated to the gym, it may be necessary to provide the national id number of the subject which wants to access to such gym. Therefore, since the service provider associated to the second computer equipment is a gym, the data selected from the selected wallet may be the national id number. Evidently, further credentials may be selected in a substantially similar way.

In examples, usage rights related to the user may also be selected. For example, the service provider associated to the second computer equipment may be a particular type of shop. In this respect, it may have been pre-established that, in order to be authorized to access the computer equipment associated to the shop, it may be necessary to provide proof that the subject is above 18 years old and/or that the subject is in possession of a particular vaccination certificate. Thus, in this example, the data selected from the selected ID wallet may be a right of use related to the user. A zero-knowledge protocol is implemented. In this protocol, the first computer equipment may prove to the computer equipment adapted to manage the data that a given statement (the subject is above eighteen years old and/or the subject is in possession of a predetermined vaccination certificate) is true while the first computer equipment avoids conveying any additional information apart from the fact that the statement is indeed true. The security of the communications between both computer equipment is thus improved.

In examples, instead of receiving a request delivered by the computer equipment adapted to manage the data, by the first computer equipment, as hereinbefore described, the first computer equipment may receive a direct request to access such first computer equipment by the subject (which may also want to access the gym facilities associated to the computer equipment adapted to the subject). The request may include a subject identifier related to the subject which wants to access a corresponding wallet of the first computer equipment. The subject identifier may be provided by the subject itself or it may be retrieved from a database (wherein the subject identifier may be associated e.g., to the real name of the subject).

In any case, the subject identifier data, directly provided to the first computer equipment, may be compared with the corresponding subject identifier data of the digital wallets which are running in the first computer equipment. In case of positive result in the comparison (i.e., in case there is a match between the subject identifier data provided in the request and the corresponding subject identifier data of one of the digital wallets running in the computer), the corresponding digital id wallet may be selected.

Once the wallet has been selected, the first computer equipment may receive a data signal including information regarding computer equipment adapted to manage the data (e.g., to identify the type of second computer equipment). For example, the received data signal may include information about if the second computer equipment includes (or not) biometric terminals for the access control. Based on the information received, the subject may be queried, via a user interface, to validate the computer equipment adapted to manage the data. In case of positive result in the validation (e.g., if information is received which confirms that the computer equipment adapted to manage the data comprises biometric functionality) the user may validate the computer equipment adapted to manage the data (i.e., the computer equipment adapted to manage the data is a computer which includes the biometric terminals as desired) and data related to the user (e.g., the national identification number) may be selected from the data stored in the digital wallet, as hereinbefore described.

In block 304, the selected data related to the subject may be provided (sent), from the first computer equipment to the computer equipment adapted to manage the data.

Following the example in which the national identification number of the subject which wants to access the second computer equipment has been selected among all the data contained in the selected digital id wallet (which is running in the first computer equipment), such national identification number may be sent to the computer equipment adapted to manage the data.

Moreover, further information contained in the digital ID wallet may also be sent to the computer equipment adapted to manage the data. For example, a first vector representing biometric feature of the subject, a subject identifier and/or usage right data may also be sent to the computer equipment adapted to manage the data. The information sent to the computer equipment adapted to manage the data may be used, by such computer equipment, to authorize (or not) the access of the subject to the computer equipment adapted to manage the data associated to a service provider, as will be described later on.

Moreover, the data related to the subject may be digitally signed. Additionally, the digitally signed data may be timestamped.

The digital signature may be considered a good way to guarantee the integrity of the content of the data related to the subject. This digital signature and related data may be stored in a repository, such as e.g., a repository of certification data.

Further, the digital signature may include a timestamp token that will undoubtedly establish the precise date and time at which the certification file was digitally signed. This timestamp may be provided by an RFC 3161 compliant independent Time Stamping Authority (TSA). This timestamp token and related data may be stored in a repository, such as e.g. the repository of certification data.

According to the RFC 3161 standard, a trusted timestamp is a timestamp issued by a trusted third party (TTP) acting as a Time Stamping Authority (TSA). It is used to prove the existence of certain data before a certain point (e.g. contracts, research data, medical records, etc.) whilst preventing anyone from backdating the timestamps. Multiple TSAs can be used to increase reliability and reduce vulnerability.

Due to the fact that digital signatures are based on cryptographic algorithms that can be broken in the future, the digital signature of a digitally signed data related to the subject will be considered valid for a limited period of time, after which the signature will expire. In order to keep the digital signature of the data related to the subject in force, some examples of the method may comprise periodically digitally signing over the certification file and adding a timestamp to the new digital signature. This periodic signature and time-stamp may be generated e.g. a reasonably short time before the expiration of the current signature and related time-stamp.

Consequently, by signing the data related and timestamping the data related to the subject it is possible to prove the content of such data in a reliable way. For example, if a subject decides to enter to his corresponding digital id wallet and share his first biometric vector with a computer equipment only during a period of one month. Then, the biometric vector must be timestamped in order to check that the vector has only been used during the allowed period of time.

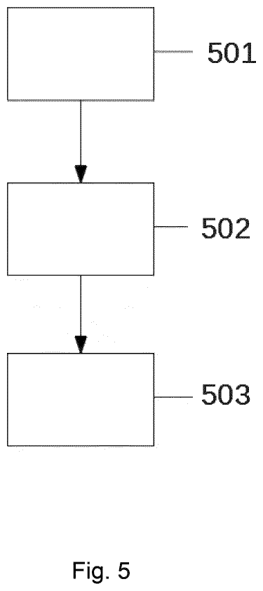

FIG. 5 is a flow chart of a method for managing data provided from a first computer equipment. The first computer equipment and the computer equipment adapted to manage the data may be the same as hereinbefore described.

At block 501, a biometric mathematical representation of physical characteristics of a subject t may be obtained by the computer equipment adapted to manage the data.

The biometric mathematical representation of physical characteristics of the subject may have been obtained by capturing one or more physical characteristics representative of the subject, each physical characteristic containing a biometric feature of the subject, identifying the biometric feature in the captured physical characteristics, and generating the biometric mathematical representation of physical characteristics of the subject.

Alternatively, a machine-readable optical label may be provided based on the biometric mathematical representation of physical characteristics of the subject. Then, the machine-readable optical label may be read such that the biometric mathematical representation of physical characteristics of the subject is decoded. In any case, the biometric mathematical representation of physical characteristics of the subject (e.g., a vector) may be obtained as hereinbefore described with reference to FIG. 1.

At block 502, the obtained biometric mathematical representation of physical characteristics of the subject may be compared with one or more first biometric mathematical representations. The first biometric mathematical representations may have been previously received by the computer equipment adapted to manage the data as hereinbefore described. Particularly, the first biometric mathematical representations may have been actively sent from a corresponding digital ID wallet running in the first computer equipment after the subject has been identified in such wallet. In some examples, a machine-readable optical label may be provided based on a first biometric mathematical representation of the subject. Then, the machine-readable optical label may be decoded, by the computer equipment adapted to manage the data, such that the first biometric mathematical representation representing a biometric feature of the subject is obtained.

In examples, the first biometric mathematical representations may be stored in a database. It is noted that each first biometric mathematical representation will be associated with a subject identifier related to the subject which wants to access the second computer equipment. The subject identifier may be the same as hereinbefore described.

At block 503, in case of positive result in the comparison (i.e., in case there is match between the biometric mathematical representation of physical characteristics of the subject and one of the first biometric mathematical representations of the same subject), the subject identifier associated to the selected first biometric mathematical representation is sent, to the first computer equipment, wherein the subject identifier is related to the subject which wants to access the computer equipment adapted to manage the data.

The first computer equipment may thus receive the subject identifier and it may provide (send) selected data related to the subject (e.g., a first vector representing biometric feature of the subject, a subject identifier data, identification data related to the subject, and/or usage right data), from a selected digital ID wallet which is running in such first computer equipment, to the computer equipment adapted to manage the data, as hereinbefore described.

As a result, data related to the subject may be received, by the computer equipment adapted to manage the data, from a digital wallet of the first computer equipment. The received data related to the subject may be compared with (the same) data related to the subject which has been previously stored e.g., in a database. In case of positive result in the comparison (i.e., if there is a match between the received data related to the subject and the data related to subject which has been previously stored e.g., in a database), the subject may be authorized to access to the computer equipment adapted to manage the data (and thus to the service provider associated to the second computer equipment).

Additionally, all the data received by the computer equipment adapted to manage the data may be deleted after a pre-set period of time. Specifically, the subject may set a time limit or a period of time after which the data received by the computer equipment adapted to manage the data will be automatically deleted. Particularly, the data may include an expiration date. The computer equipment adapted to manage the previously received data may check regularly (e.g., every hour or every day) whether the data has expired. In case of positive result in the checking (i.e., in case the data has already expired), the data may be deleted from the computer equipment adapted to manage the data.

In case the data is not actually sent to the computer equipment adapted to manage the data but it is merely provided to computer equipment adapted to manage the data (e.g., in the form of QR code), the first computer equipment may check regularly (e.g., every hour or every day) whether the data has expired. In case of positive result in the checking (i.e., in case the data has already expired), the data may be deleted from the first computer equipment.

In some other examples, a request may be received by the computer equipment adapted to manage the data indicating that the computer must delete the data

In some examples, the data received by the computer adapted to manage the data may be a temporary credential (i.e., the credential may expire after a predetermined period of time). For example:
The temporary credential may be a conventional QR code which may be read by a capturing device such that the subject may be authorized to access the computer equipment adapted to manage the data,
The temporary credential may be an identification code or first biometric vector which may be transmitted using NFC or Bluetooth,
The temporary credential is a picture of the user which wants to be authorized to access the computer equipment adapted to manage the data and the picture may be transmitted using NFC technology.

It is noted that the present invention provides the following advantages:
A user may have control over the data which is to be shared with the computer equipment adapted to manage the data (for authentication and/or authorization), as well as the time period for which the data is to be shared,
A user may have control to generate ephemeral representations of the data that may be provided to the computer equipment adapted to manage the data (e.g. using the optical tag or NFC communications), preventing a “conventional” transfer of data between both computers is prevented,
The interoperability of different providers of the computer equipment adapted to manage the data is improved,
the data shared between the first and computer equipment adapted to manage the data may be enriched.

Although only a number of examples have been disclosed herein, other alternatives, modifications, uses, and/or equivalents thereof are possible. Furthermore, all possible combinations of the described examples are also covered. Thus, the scope of the present disclosure should not be limited by particular examples, but should be determined only by a fair reading of the claims that follow.

What is claimed is:

1. A method for providing data from a first computer equipment to a computer equipment adapted to manage the data, the method comprising:
providing one or more digital wallets, wherein each digital wallet comprises data related to a subject to be authorized to access the computer equipment adapted to manage the data;
selecting a digital wallet among the provided digital wallets;
selecting data related to the subject, from the selected digital wallet, based on a service provider associated to the computer equipment adapted to manage the data;
providing the selected data related to the subject to the computer equipment adapted to manage the data.

2. A method according to claim 1, wherein the data related to the subject comprise one or more of the following:
a first biometric mathematical representation of the subject, specifically a first vector representing biometric feature of the subject;
subject identifier data;
identification data related to the subject; and/or
usage right data.

3. A method according to claim 1, further comprising
assigning a time to the data related to the subject after which the data related to the subject is to be deleted.

4. A method according to claim 2, further comprising after providing one or more digital wallets:
receiving a request, by the first computer equipment, in which the subject requests to be authorized to access the computer equipment adapted to manage the data, wherein the request includes subject identifier data related to the subject which is to be authorized to access the computer equipment adapted to manage the data;
comparing the received subject identifier data with the subject identifier data comprised in the digital wallets;
in case of positive result in the comparison, selecting the corresponding digital wallet.

5-6. (canceled)

7. A method according to claims 2, further comprising after providing one or more digital wallets:
receiving a request in which the subject requests to be authorized to access the first computer equipment, wherein the request includes either subject identifier data or a biometric mathematical representation of physical characteristics;
comparing the received subject identifier data with the corresponding subject identifier data comprised in the digital wallets or the biometric mathematical representation of physical characteristics with the corresponding first biometric mathematical representation comprised in the digital wallets;
in case of a positive result in the comparison, selecting the corresponding digital wallet.

8. A method according to claim 7, further comprising
receiving a data signal to identify the type of computer equipment adapted to manage the data;
querying the subject to validate, via a user interface, the computer equipment adapted to manage the data based on the received data signal;
in case of a positive result in the validation, selecting data related to the subject, from the selected digital wallet, based on the service provider associated to the computer equipment adapted to manage the data at which the subject is to be authorized to access.

9-10. (canceled)

11. A computer program product comprising program instructions for causing a first computer equipment to perform a method according to claim 1.

12. A first computer equipment adapted to provide data to a computer equipment adapted to manage the data, comprising:
means for providing one or more digital wallets, wherein each digital wallet comprises data related to a subject to be authorized to access the computer equipment adapted to manage the data;
means for selecting a digital wallet among the provided digital wallets;
means for selecting data related to the subject, from the selected digital wallet, based on a service provider associated to the computer equipment adapted to manage the data;
means for providing the selected data related to the subject to the computer equipment adapted to manage the data.

13. A method for managing data provided by a first computer equipment, the method comprising:
obtaining a biometric mathematical representation of physical characteristics of a subject which is to be authorized to access a computer equipment adapted to manage the data;
obtaining one or more first biometric mathematical representations of the subject;
comparing the obtained biometric mathematical representation of physical characteristics of the subject with the obtained first biometric mathematical representations;
in case of positive result in the comparison, selecting the corresponding first biometric mathematical representation, and
sending subject identifier data, associated to the selected first biometric mathematical representation of the subject, to the first computer equipment, wherein the subject identifier data is related to the subject which is to be authorized to access a computer equipment adapted to manage the message.

14. A method according to claim 13, wherein obtaining the biometric mathematical representation of physical characteristics of the subject comprises:
capturing one or more physical characteristics representative of the subject, each physical characteristic containing a biometric feature of the subject;
identifying the biometric feature in the captured physical characteristics; and
generating the biometric mathematical representation of physical characteristics of the subject representing the identified feature.

15. A method according to claim 13, wherein obtaining the first biometric mathematical representations of the subject comprises:
providing a machine-readable optical label based on a first biometric mathematical representations of the subject;
reading the machine-readable optical label to decode the first biometric mathematical representations of the subject.

16. A method according to claim 13, the method further comprising:
receiving data related to the subject from a digital wallet comprised in the first computer equipment;
authorizing the access of the subject to the computer equipment adapted to manage the data based on the received data.

17. A method according to claim 16, wherein authorizing the access of the subject to the computer equipment adapted to manage the data based on the received data comprises:
comparing the data related to the subject obtained from the digital wallet comprised in the first computer equipment with the same data related to the subject stored in a database;
in case of positive result of the comparison, authorizing the access of the subject to the computer equipment adapted to manage the message.

18. A method according to claim 14, wherein capturing one or more physical characteristics comprises capturing one or more of an image, an audio, a video, a biological, or a chemical sample of the subject, specifically capturing an image comprises capturing an image with one or more of a portion of a face, of a palm, of a fingerprint, of an eye, of ears, of a nose, of teeth, of a tongue, of palm veins pattern, or of finger veins pattern, of the subject.

19. A method according to claim 13, wherein the first biometric mathematical representations of the subject have been previously received by the computer equipment adapted to manage the data and/or the first biometric mathematical representations of the subject are stored in a database.

20. A method according to claim 13, the method further comprising:
deleting the obtained first biometric mathematical representations of the subject and/or the obtained data related to the subject.

21. A method according to claim 20, wherein deleting the obtained first biometric mathematical representations of the subject and/or the obtained data related to the subject comprises:
obtaining a first time from a timer;
obtaining a second time previously assigned to the data related to the subject or to the first biometric mathematical representations of the subject;
checking whether the first time is above the second time;
in case of positive result in the checking, deleting the corresponding first biometric mathematical representations of the subject and/or the corresponding data related to the subject.

22. A method according to claim 20, wherein deleting the first biometric mathematical representations of the subject and/or the obtained data related to the subject further comprises:
receiving a request, from the first computer equipment, for deleting the first vectors and/or the obtained data related to the subject.

23. A computer equipment adapted to manage data provided by a first computer equipment, comprising:
means for obtaining a biometric mathematical representation of physical characteristics of a subject which is to be authorized to access the computer equipment;
means for obtaining one or more first biometric mathematical representations of the subject;
means for comparing the obtained biometric mathematical representation of physical characteristics of the subject with the obtained first biometric mathematical representations;
in case of positive result in the comparison, selecting the corresponding first biometric mathematical representation, and
means for sending a subject identifier, associated to the selected first biometric mathematical representation of the subject, to the first computer equipment, wherein the subject identifier is related to the subject which is to be authorized to access a computer equipment adapted to manage the message.

24. A computer program product comprising program instructions for causing a computer equipment adapted to manage data to perform a method according to claim 13.
